(19) United States
(12) Patent Application Publication
(10) Pub. No.: US 2014/0260562 A1
(43) Pub. Date: Sep. 18, 2014

(54) METHOD OF MEASURING THE DIGESTIBILITY OF A FOOD PROTEIN

(71) Applicant: Safa MOTLAGH, Dayton, OH (US)

(72) Inventor: Safa MOTLAGH, Dayton, OH (US)

(21) Appl. No.: 13/803,310

(22) Filed: Mar. 14, 2013

(51) Int. Cl. G01N 30/00

(52) U.S. Cl. CPC G01N 30/00
USPC 73/61.52; 426/56; 426/7

(57) ABSTRACT

A method of measuring digestibility of food proteins is disclosed, the method comprising using protease enzymes in combination with an ultra filtration step.

### TECHNICAL FIELD

The present invention relates to a method for measuring the digestibility of a food protein. More specifically, the present invention relates to an in-vitro digestibility assay for animal food proteins using ultra filtration.

### BACKGROUND OF THE INVENTION

The digestibility of protein-containing human food or protein-containing animal food can vary greatly as a result of the proteins selected. During digestion in the body, proteins, either as single ingredients or as part of a protein-containing composition, contact digestive enzymes. These digestive enzymes hydrolyze peptide bonds in the proteins to release individual amino acids. These amino acids are then free to be absorbed into the body, thereby providing nutritional benefits. Conversely, the amino acids that are not hydrolyzed remain in the body until they are excreted as waste. It is important to identify proteins and amino acids that provide maximum digestibility in order to formulate protein-containing compositions that have maximum nutritional value.

Digestibility may be measured by using in vivo or in vitro assays. Two common in vivo assays are the Protein Efficiency Ratio (PER) assay and the True Amino Acid Digestibility (TAAD) assay. Because these in vivo assays are difficult to perform, require the use of animals, and do not use the species of interest (these assays use birds), several alternative, in vitro, digestibility assays have been developed.

One of these in vitro enzyme digestibility assays, Immobilized Digestive Enzyme Assay (IDEA), utilizes enzymes which are covalently immobilized on large-pore diameter glass beads via an amide linkage with silica. These immobilized enzymes are contacted with the proteins being assayed, and the extent of peptide bond hydrolysis is estimated using, for example, an o-phthalaldehyde (OPA) method by which a single absorbance measurement is taken and translated into individual amino acid concentrations. While this method is beneficial in that it does not use animal testing, it is time consuming and requires a first preparation step of immobilizing enzymes. Furthermore, this method suffers in that it identifies released amino acids statistically, not physically, by making assumptions about individual amino acid levels based solely on a single absorbance measurement.

There is a need for an in vitro digestibility assay that quickly and effectively measures the digestibility of a wide variety of proteins. There is also a need for an in vitro digestibility assay that accurately measures released amino acids to determine the overall digestibility of a protein or protein-containing composition, and the digestibility of individual amino acids.

### SUMMARY OF THE INVENTION

There is herein disclosed a method of measuring the digestibility of a food protein comprising: (a) preparing a defatted protein source from a food protein; (b) suspending the defatted protein source in a buffering system to form a buffered protein source suspension; (c) adding an enzyme-containing solution to the buffered protein source suspension in step (b); (d) incubating the enzyme and buffered protein source suspension of step (c) for a time sufficient to allow the enzyme to cleave the buffered protein source into separate amino acids; (e) optionally centrifuging the suspension of step (d); (f) separating the separate amino acids from the enzyme and buffered protein source suspension by ultra filtration; and (g) analyzing the separate amino acids.

The invention is also directed to a method of measuring the digestibility of a food protein, the method comprising: (a) preparing a defatted protein source from a pet food composition comprising a food protein by grinding the protein source and combining it with isopropanol; (b) suspending the defatted protein source in a buffering system to form a buffered protein source suspension; (c) adding an enzyme-containing solution to the buffered protein source in step (b), the enzyme being selected from the group consisting of trypsin, chymotrypsin, intestinal peptidase, and mixtures thereof; (d) incubating the enzyme and buffered protein source solution of step (c) for a time sufficient to allow the enzyme to cleave the buffered protein source into separate amino acids; (e) optionally centrifuging the solution of step (d); (f) separating the separate amino acids from the enzyme and buffered protein source solution by ultra filtration; and (g) analyzing the separate amino acids by ultra high performance liquid chromatography.

Additionally, the present invention is also directed to a method of measuring digestibility of a food protein, the method comprising: (a) preparing a defatted protein source from a food protein by: (i) grinding about 10 g to about 1000 g of the food protein; (ii) centrifuging the ground food protein, the ground food protein separating into fat and the defatted protein source; and (iii) separating out the defatted protein source; (b) suspending the defatted protein source in a buffering system to form a buffered protein source suspension by: (i) adding a buffering system to the defatted protein source, the buffering system comprising phosphoric acid and sodium azide; (ii) adjusting the pH of the buffering system to a pH of about 6.2 to about 8.2 by addition of sodium hydroxide; (c) cleaving the defatted protein source into separate amino acids by: (i) adding a protease enzyme-containing solution comprising water and trypsin; (ii) adding another protease enzyme-containing solution comprising water and chymotrypsin; and (iii) adding another protease enzyme-containing solution comprising water and peptidase; (iv) incubating the defatted protein source and enzyme solutions of steps (c)(i)-(c)(iii) for 18 hours; and (v) centrifuging the defatted protein source and enzyme solutions of step (c)(iv) to form a supernatant comprising the separate amino acids; (d) collecting the separate amino acids by: (i) pipetting the supernatant comprising the separate amino acids into a 3,000 molecular weight centrifugal ultra filter; (ii) centrifuging the supernatant at 14,000 g-forces for about twenty minutes; and (iii) removing the separate amino acids-containing solution from the top of the ultra filter; (e) analyzing the separate amino acids by ultra high performance liquid chromatography.

### BRIEF DESCRIPTION OF THE DRAWINGS

The detailed description of the drawings particularly refers to the accompanying figures in which:

FIG. 1 is a comparison of prior art in vivo assays, TAAD and PER, to the present in vitro invention digestive enzyme assay using ultra filtration.

### DETAILED DESCRIPTION

It has been found that an in vitro digestibility enzyme assay using ultra filtration methods to physically separate amino acids can quickly and effectively measure digestibility of proteins both individually, and as part of a protein-containing composition. The present invention physically separates released amino acids from a protein source using an ultra filtration step. By collecting amino acids using ultra filtration, the amino acids are able to be quantified and analyzed to measure overall protein digestibility and individual amino acid digestibility.

The assay of the present invention has many benefits over other in vitro assays, such as IDEA. The present invention does not require the additional step of binding protease enzymes which in the IDEA method functions to prevent autolysis (self-digestion) of the enzyme. Because the present invention uses ultra filtration to physically separate the hydrolyzed amino acids from the remaining enzyme-protein solution, there is no need to bind the protease enzymes to prevent autolysis since the enzymes will be filtered out before they can self digest.

In addition, the physical separation and collecting of separate amino acids by ultra filtration allows for more accurate determinations of protein digestibility as compared to IDEA which relies on statistical modeling. As can be seen in FIG. 1, the amino acid analysis of the present invention is comparable to in vivo animal model testing, which is widely accepted in the art as a model of mammalian digestibility. Therefore, without having to use animal testing, the present invention is able to quickly and accurately evaluate how digestible a source of protein is by analyzing its released amino acids. The present invention results for protein digestibility have a coefficient of variation (CV) of less than 2.0%.

The present invention can be used to accurately analyze both protein-containing human food and protein-containing animal food, for example, dog and cat food. In addition, the present invention is able to accurately analyze both individual food proteins, and also food proteins in compositions. Since proteins included in food compositions have usually undergone processing, there is traditionally some changes observed in digestibility. Common processing steps include heating, which essentially functions to help prematurely “digest” the proteins in the food composition. The IDEA model is unable to measure the digestibility of processed food compositions. However, processing does not negatively impact the present invention which physically filters out the separated amino acids regardless of a processing step.

The digestive enzyme assay of the present invention measures the digestibility of food proteins or protein-containing compositions and individual amino acids by a method involving the steps of: removing fat from the food proteins; adding a buffering system to form a buffered protein source suspension; adding an enzyme-containing solution to the buffered protein source suspension for a time sufficient to allow the enzymes to cleave the buffered protein source into separate amino acids; separating the separate amino acids from the enzyme and buffered protein source by ultra filtration; and analyzing the separate amino acids individually. These steps can be performed in the order displayed above, or any alternative order. The food proteins analyzed may be from any suitable protein source, but in one embodiment, the protein source is selected from the group consisting of egg, casein, soybean, chicken, beef, and mixtures thereof.

### A. Fat Removal

In one embodiment, fat is first removed from the food protein or protein-containing composition. It is important to remove the fat because a fat coating on a protein prevents enzymes from accessing the protein for hydrolysis.

In one embodiment, from about 10 g to about 1,000 g; in another embodiment from about 100 g to about 500 g; in another embodiment from about 90 g to about 105 g; in another embodiment about 100 g, of food protein is ground using any conventional grinding tool. In one embodiment, the grinding tool is selected from the group consisting of a commercially available Straub® grinder, a commercially available Retsch® grinder, a commercially available coffee mill, and combinations thereof. The food protein can be ground more than once; in one embodiment the food protein is ground in three separate steps; in one embodiment, each step uses a different grinding tool. In one embodiment, the food protein is ground in three separate steps, the first step using a commercially available Straub® grinder, the second step using a commercially available Retsch® grinder, and the third step using a commercially available coffee mill grinder.

After grinding, the ground protein source may be transferred to a 15 ml centrifuge tube and the weight of the tube plus ground protein source is recorded. For individual food proteins, the food protein is now a defatted protein source and can be buffered. For protein-containing compositions, an organic solvent, in one embodiment isopropanol, may be added to the test tube. In one embodiment, from about 0.1 ml to about 10 ml, in another embodiment from about 0.5 ml to about 1.5 ml, in another embodiment about 1.0 ml, of isopropanol is added to the test tube containing the ground protein source. The test tube is then capped and vortexed for a time sufficient to suspend the protein source in the isopropanol; in one embodiment for about 3 seconds to about 6 seconds, in another embodiment for about 5 seconds. After the ground protein source is suspended, the test tube is placed on a rocker for about 1 minute to about 30 minutes, in another embodiment for about 3 minutes to about 6 minutes, in another embodiment for about 5 minutes.

In one embodiment, the test tube containing the isopropanol and ground protein source is then centrifuged at high speed, in one embodiment at a speed of about 2400 rcf. The test tube is centrifuged for about 3 minutes to about 6 minutes, in another embodiment is centrifuged for about 5 minutes. The resulting supernatant is discarded and the remaining defatted protein source is dried. In one embodiment, the defatted protein source is placed under nitrogen gas and warmed at a temperature of from about 35° C. to about 100° C., for a time of from about 5 minutes to about 60 minutes. In one embodiment, the defatted protein source is warmed under nitrogen gas at a temperature of about 40° C., for about 30 minutes. The flow of nitrogen gas should be barely perceptible from the end of the gas nozzle to ensure that the defatted protein source is not blown out of the test tube. After drying the protein source, the test tube is removed from the drier and tapped to break up the defatted protein source. The tube is then placed back in the drier for an additional period of time; in one embodiment about 30 minutes.

### B. Buffering System

In one embodiment, a buffering system is added to the defatted protein source to maintain a pH that facilitates the subsequent enzyme hydrolysis of the proteins. In one embodiment, from about 1.0 ml to about 100 ml, in another embodiment from about 5 ml to about 50 ml, in another embodiment from about 9 ml to about 11 ml, in another embodiment about 10 ml, of phosphoric acid is added to the defatted protein source. In another embodiment, 0.1% of an antimicrobial agent, in one embodiment sodium azide, is mixed with the above described phosphoric acid and added to the defatted protein source. In one embodiment, about 14 ml of 85% phosphoric acid, about 4 liters of water, and about 4 grams of sodium azide is added to the defatted protein source to form a protein suspension. The resultant suspension is vortexed for about 2 seconds to about 60 seconds, in another embodiment for about 4 seconds to about 20 seconds, in another embodiment for about 5 seconds, and is then placed on a rocker for about 2 hours.

In one embodiment, sodium hydroxide is then added to the defatted protein source after the approximately two hour rocking step. In one embodiment, from about 190 μl to about 570 μl, in another embodiment from about 350 μl to about 450 μl, in another embodiment about 380 μl, of 2.0 M sodium hydroxide is added to the test tube. The test tube is then inverted. In one embodiment, the test tube is inverted at least one time, in another embodiment, at least three times. The final buffered protein source suspension has a pH of from about 6.2 to about 8.2, in another embodiment from about 7.0 to about 7.5, in another embodiment about 7.2.

### C. Enzyme Solution

In one embodiment, an enzyme-containing solution is added to the buffered protein source suspension within 30 minutes, in another embodiment within 20 minutes, of completing the final buffering step. This timing is to ensure that enzyme autolysis is minimized. The enzymes in the enzyme-containing solutions are added to hydrolyze the proteins into separate amino acids. Enzymes are selected from proteases, which are a class of enzymes that are capable of hydrolyzing peptide bonds in proteins to release individual amino acids. Examples of proteases are pepsin, trypsin, chymotrypsin, intestinal peptidase, papain, and keratinase.

In one embodiment, the protease enzymes trypsin, chymotrypsin, and intestinal peptidase are added to the buffered protein source suspension in three separate steps. In another embodiment, trypsin, chymotrypsin, and intestinal peptidase are added to the buffered protein source suspension in a single step. In one embodiment, trypsin is added to the buffered protein source suspension in a first step, chymotrypsin is added in a second step, and intestinal peptidase is added in a third step.

In one embodiment, a trypsin solution is formed and added to the buffered protein source suspension in a first step. A trypsin solution may be formed by combining about 5000 ml of water and about 121 mg of trypsin (available from Sigma, St. Louis, Mo., T0303) in a 500 ml Erlenmeyer flask, and then mixing the solution in the flask. If less trypsin is used, the volume of water should be reduced proportionately to keep the enzyme solution concentration constant. In one embodiment the trypsin solution concentration is from about 300 units/ml to about 350 units/ml, in another embodiment about 340 units/ml, wherein units is a measure of the amount of enzyme that catalyzes the conversion of 1 micro mole of substrate per minute. In one embodiment, 121 mg of trypsin having an activity level of 14,000 units/mg is combined with 5000 ml of water in a flask to form a trypsin solution having a concentration of about 340 units/ml. Once mixed, from about 20 μl to about 25 μl, in another embodiment about 22 μl, of trypsin solution is added to the buffered protein source suspension.

In one embodiment, a chymotrypsin solution is formed and added to the buffered protein source suspension in a second step. A chymotrypsin solution may be formed by combining about 50 ml of water with about 100 mg of chymotrypsin (available from Sigma, St. Louis, Mo., C4129) in a 50 ml centrifuge tube, and mixing the solution in the centrifuge tube. If less chymotrypsin is used, the volume of water should be reduced proportionately to keep the enzyme solution concentration constant. In one embodiment, the chymotrypsin solution concentration is from about 100 units/ml to about 115 units/ml, in another embodiment about 110 units/ml. In one embodiment, 50 ml of water is combined with 100 mg of chymotrypsin having an activity level of 55 units/mg to form a chymotrypsin solution having a concentration of about 110 units/ml. Once mixed, about 345 μl of the chymotrypsin solution is added to the buffered protein source suspension.

In one embodiment, an intestinal peptidase solution is formed and added to the buffered protein source suspension in a second step. An intestinal peptidase solution may be formed by combining about 10 ml of water with about 0.078 mg of intestinal peptidase (available from The Procter & Gamble Company, Cincinnati, Ohio) in a 15 ml centrifuge tube, and mixing the solution in the centrifuge tube. If less intestinal peptidase is used, the volume of water should be reduced proportionately to keep the enzyme solution concentration constant. In one embodiment, the intestinal peptidase solution concentration is from about 0.5 units/ml to about 1.0 units/ml, in another embodiment about 0.8 units/ml, wherein units is a measure of the activity of the enzyme. In one embodiment, 10 ml of water is combined with 0.078 mg of intestinal peptidase having an activity level of 102 units/mg to form an intestinal peptidase solution having a concentration of about 0.796 units/ml. Once mixed, about 1 ml of the intestinal peptidase solution is added to the buffered protein source suspension.

The resultant enzyme and buffered protein source suspension may be incubated at a temperature of from about 30° C. to about 47° C., in another embodiment from about 35° C. to about 40° C., for about 20 hours. In one embodiment, the enzyme and buffered protein source suspension is incubated at 37° C. for about 18 hours.

In one embodiment, the enzyme and buffered protein source suspension is then centrifuged at about 2400 relative centrifugal force (rcf) for about 5 minutes to form a supernatant comprising separated amino acids.

### D. Ultra Filtration

DEA uses ultra filtration to physically separate the separated amino acids from the remaining enzyme and buffered protein source suspension. In one embodiment, from about 50 μl to about 800 μl, in another embodiment from about 450 μl to about 600 μl, in another embodiment about 500 μl, of centrifuged supernatant is placed into an ultra filtration device. In one embodiment, the supernatant is pipetted into a 3,000 molecular weight Nanosep PES (polyethersulfone) centrifugal ultra filter (available from Pall, Port Washington, N.Y.). In one embodiment, the supernatant is then centrifuged at about 7,000 to about 21,000 g-forces for about 10 to about 30 minutes. In another embodiment, the supernatant is centrifuged at about 14,000 g-forces for about 20 minutes. The separate amino acids are then collected from the enzyme and buffered protein source suspension by ultra filtration. Ultra filtration serves to (1) stop the enzymatic reaction time by physically separating the separate amino acids that have been produced by the enzyme and protein reaction, and (2) clean up the solution and prepare it for further analysis.

### E. Digestibility Analysis

After separating the separate amino acids from the remaining enzyme and buffered protein source suspension, the amino acids are analyzed using digestibility analysis. In one embodiment, about 100 μl of the filtrate containing separated amino acids is diluted with about 900 μl of water. The diluted filtrate is then ready to be analyzed by any known method in the art. In one embodiment, the diluted filtrate is analyzed by ultra high performance liquid chromatography (UPLC). UPLC is a separating technique that separates amino acids from each other and from other sample components. These separated amino acids can then be detected and measured using a variety of detectors such as ultra violet/visible spectrophotometers, florescence spectrophotometers, mass spectrometers, and combinations thereof.

### EXAMPLES

### Example 1

### Comparison of Prior Art In Vivo Assays, TAAD and PER, to the Present Invention Digestive Assay Using Ultra Filtration

Various food proteins (listed in Table 1), are analyzed using the DEA assay method and compared to historical TAAD and PER values. The DEA method is carried out below:

1.1 Grind around 100 g of sample 3× using a Straub® grinder, a Retsch® grinder, and a coffee mill (in that order);

1.2 Accurately weigh between 100 and 105 mg of sample into a 15 ml centrifuge tube and record weight;

1.3 Add 1 ml of isopropanol, cap and vortex for 5 s to suspend solid, then place on a rocker to mix for 5 min;

1.4 Centrifuge at high speed (2440 rcf) for 5 min;

1.5 Carefully pipette out the supernatant and discard the liquid;

1.6 Dry the defatted sample under N₂ with warming (about 40° C.) for 30 min. Remove tube from drier, hold it vertically, and tap the bottom of the tube with your finger to break up the plug of defatted feed (make sure sample is not lost in this step). Place tube back in drier and continue to dry for another 30 min;

1.7 Add 10 ml of 0.3% H₃PO₄+0.1% sodium azide (14.12 ml of 85% H₃PO₄+4 L H₂O+4 g NaN₃) acid buffer to defatted sample, cap and vortex for 5 seconds to ensure that the plug at the bottom of tube is dispersed. Place on rocker to mix for 2 hours;

1.8 Add 380 ml of 2.0 M NaOH (purchase titration grade) to the suspension and invert 3× (the pH of the solution at this point should be around 7.2);

1.9 Prepare a 340 unit/ml trypsin (Sigma P/N T0303) solution by adding 5000 ml water to 121 mg trypsin (14000 unit/mg activity) in a 500 ml Erlenmeyer flask (this makes enough enzyme solution for approx. 22,700 samples) and mix. Add 22 ml of this solution to the suspension;

1.10 Prepare a 110 unit/ml chymotrypsin (Sigma P/N C4129) solution by adding 50 ml water to 100 mg chymotrypsin (55 unit/mg activity) in a 50 ml centrifuge tube (this makes enough enzyme solution for approx. 140 samples) and mix. Add 345 ml of this solution to the suspension;

1.11 Prepare a 0.796 unit/ml intestinal peptidase (from porcine intestinal mucosa, Sigma P/N P7500) solution by adding 10 ml water to 0.078 mg peptidase (102 U/g activity) in a 15 ml centrifuge tube (this makes enough enzyme for approx. 10 samples) and mix. Add 1 ml of this solution to the suspension;

1.12 Incubate with gentle rocking at 37° C. for 18 hours;

1.13 Discard all excess enzyme solutions;

1.14 Centrifuge the digest at 2440 rcf for 5 min;

1.15 Carefully pipette approximately 500 ml of the supernatant into a 3,000 molecular weight Nanosep PES centrifugal ultra filter (Pall P/N OD003C35) and centrifuge at 14000 g-forces for 20 min;

1.16 Dilute 100 ml of the filtrate with 900 ml water. The sample is ready for amino acid analysis by UPLC and comparison to TAAD and PER data values.

TABLE 1
COMPARISON OF TAAD AND PER
WITH PRESENT INVENTION

| | Present Invention | TAAD | PER |
|---|---|---|---|
| | (mg AA/grams of | (% of amino acids | (% of amino acids |
| Ingredient | protein) | absorbed) | absorbed) |
| Refined | 286 | 84 | 62 |
| Chicken Meal | | | |
| Prime Chicken | 292 | 85 | 61 |
| Meal | | | |
| Fish Meal 18 | 400 | 92 | 78 |
| Menhaden Fish | 403 | 90 | 69 |
| Meal | | | |
| High Ash | 441 | 94 | 79 |
| Chicken | | | |
| Low Ash | 478 | 97 | 95 |
| Chicken | | | |

As can be seen in FIG. 1 and Table 1, the amino acid values for the present invention correlate to TAAD and PER amino acid analysis values which are commonly accepted in the art as being the reference standard for analysis values. TAAD and PER give percentage values of absorbed amino acids based on in vivo animal testing. The present invention uses in vitro testing to collect and analyze released amino acids. There is a direct correlation between absorbed amino acids and released amino acids since the released amino acids are able to be absorbed into the body. Therefore, a correlation can be seen between PER and TAAD and the present invention.

### Example 2

### Digestibility Enzyme Analysis of a Protein-Containing Animal Composition

1.1 Grind around 100 g of sample 3× using a Straub® grinder, a Retsch® grinder, and a coffee mill (in that order);

1.2 Accurately weigh 102.6 mg of sample into a 15 ml centrifuge tube and record weight;

1.3 Add 1 ml of isopropanol, cap and vortex for 5 s to suspend solid, then place on a rocker to mix for 5 min;

1.4 Centrifuge at a high speed (2440 rcf) for 5 min;

1.5 Carefully pipette out the supernatant and discard the liquid;

1.6 Dry the defatted sample under N₂ with warming (about 40° C.) for 30 min. Remove tube from drier, hold it vertically, and tap the bottom of the tube with your finger to break up the plug of defatted feed (make sure sample is not lost in this step). Place tube back in drier and continue to dry for another 30 min;

1.7 Add 10 ml of 0.3% H₃PO₄+0.1% sodium azide (14.12 ml of 85% H₃PO₄+4 L H₂O+4 g NaN₃) acid buffer to defatted sample, cap and vortex for 5 seconds to ensure that plug at bottom of tube is dispersed. Place on rocker to mix for 2 hours;

1.8 Add 380 ml of 2.0 M NaOH (purchase titration grade) to the suspension and invert 3× (the pH of the solution at this point should be around 7.2);

1.9 Prepare a 340 unit/ml trypsin (Sigma P/N T0303) solution by adding 446 ml water to 108 mg trypsin in a 500 ml Erlenmeyer flask and mix. Add 22 ml of this solution to the suspension;

1.10 Prepare a 110 unit/ml chymotrypsin (Sigma P/N C4129) solution by adding 52 ml water to 104 mg chymotrypsin in a 50 ml centrifuge tube and mix. Add 340 ml of this solution to the suspension;

1.11 Prepare a 0.796 unit/ml intestinal peptidase (from porcine intestinal mucosa, Sigma P/N P7500) solution by adding 13.7 ml water to 0.078 mg peptidase in a 15 ml centrifuge tube and mix. Add 1 ml of this solution to the suspension;

1.12 Incubate with gentle rocking at 37° C. for 18 hours;

1.13 Discard all excess enzyme solutions;

1.14 Centrifuge the digest at 2440 rcf for 5 min;

1.15 Carefully pipette approximately 500 ml of the supernatant into a 3,000 molecular weight Nanosep PES centrifugal ultra filter (Pall P/N OD003C35) and centrifuge at 14000 g-forces for 20 min;

1.16 Dilute 100 ml of the filtrate with 900 ml water. The sample is ready for amino acid analysis by UPLC using the Waters AccQ-Tag Chemistry Kit.

### Results:

### Glutamic Acid Released: 1.573 mg

### Total Protein Content: 66.1%

mg of Glutamic Acid Released/g of protein: 23 mg/g of protein
The above analysis is repeated three times with three separate 100 mg portions of the ground sample. The three digestibility values obtained are:
Sample 1: 23 mg of glutamic acid/g of protein
Sample 2: 22.9 mg of glutamic acid/g of protein
Sample 3: 22.7 mg of glutamic acid/g of protein
The median value, 22.9 mg of glutamic acid/g of protein, is the glutamic acid digestibility of the protein-containing composition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of measuring digestibility of a food protein, the method comprising:
a. preparing a defatted protein source from a food protein;
b. suspending said defatted protein source in a buffering system to form a buffered protein source suspension;
c. adding an enzyme-containing solution to the buffered protein source suspension from step (b);
d. incubating the enzyme and buffered protein source suspension of step (c) for a time sufficient to allow the enzyme to cleave the buffered protein source into separate amino acids;
e. optionally centrifuging the suspension of step (d);
f. separating the separate amino acids from the enzyme and buffered protein source suspension by ultra filtration; and
g. analyzing the separate amino acids, the separate amino acids constituting a measure of the digestibility of the food protein.

2. The method of claim 1, wherein the food protein is from an animal protein source.

3. The method of claim 1, wherein the food protein is from a protein source selected from the group consisting of egg, casein, soybean, chicken, beef, and mixtures thereof.

4. The method of claim 1, wherein the fat is removed from the food protein by a process comprising grinding the food protein source in three separate steps.

5. The method of claim 4, wherein the buffering system comprises sodium hydroxide and phosphoric acid.

6. The method of claim 5, wherein the buffering system further comprises sodium azide.

7. The method of claim 6, wherein the buffered protein source suspension has a pH of from about 6.2 to about 8.2.

8. The method of claim 1, wherein the enzyme-containing solution comprises one or more protease enzymes selected from the group consisting of trypsin, chymotrypsin, intestinal peptidase, and mixtures thereof.

9. The method of claim 8, wherein the enzyme-containing solution is added to the buffered protein source suspension by first adding trypsin, secondly adding chymotrypsin, and then thirdly adding intestinal peptidase.

10. The method of claim 1, wherein the separated amino acids are analyzed by ultra high performance liquid chromatography.

11. A method of measuring digestibility of a food protein, the method comprising:
a. preparing a defatted protein source from a pet food composition comprising a food protein by grinding the protein source and combining it with isopropanol;
b. suspending said defatted protein source in a buffering system to form a buffered protein source suspension;
c. adding an enzyme-containing solution to said buffered protein source suspension from step (b), the enzyme being selected from the group consisting of trypsin, chymotrypsin, intestinal peptidase, and mixtures thereof;
d. incubating the enzyme and protein source suspension for a time sufficient to allow the enzyme to cleave the buffered protein source into separate amino acids;
e. optionally centrifuging the suspension of step (d);
f. separating the separate amino acids from the enzyme and buffered protein source suspension by ultra filtration; and
g. analyzing the separate amino acids by ultra high performance liquid chromatography.

12. The method of claim 11, wherein the food protein is from an animal protein source.

13. The method of claim 12, wherein the buffering system comprises sodium hydroxide and phosphoric acid.

14. The method of claim 13, wherein the buffering system further comprises sodium azide.

15. The method of claim 14, wherein the buffered protein source suspension has a pH of about 6.2 to about 8.2.

16. The method of claim 11, wherein the enzyme-containing solution is added to the buffered protein source suspension by first adding trypsin, secondly adding chymotrypsin, and then thirdly adding intestinal peptidase.

17. A method of measuring digestibility of a food protein, the method comprising:
(a) preparing a defatted protein source from a food protein by:
i. grinding about 10 g to about 1000 g of the food protein
ii. centrifuging the ground food protein, the ground food protein separating into fat and the defatted protein source; and
iii. separating out the defatted protein source;
(b) suspending said defatted protein source in a buffering system to form a buffered protein source suspension by:
i. adding a buffering system to the defatted protein source, said buffering system comprising phosphoric acid and sodium azide; and
ii. adjusting the pH of the buffering system to a pH of from about 6.2 to about 8.2 by addition of sodium hydroxide;
(c) cleaving the defatted protein source into separate amino acids by:
i. adding a protease enzyme-containing solution comprising water and trypsin;
ii. adding another protease enzyme-containing solution comprising water and chymotrypsin; and
iii. adding another protease enzyme-containing solution comprising water and intestinal peptidase;
iv. incubating the defatted protein source and protease enzyme-containing suspension of steps (c)(i)-(c)(iii) for 18 hours; and
v. centrifuging the defatted protein source and enzyme suspension of step (c)(iv) to produce a supernatant comprising the separate amino acids;
(d) collecting the separate amino acids by:
i. pipetting the supernatant comprising the separate amino acids into a 3,000 molecular weight centrifugal ultra filter;
ii. centrifuging the supernatant at 14,000 g-forces for about twenty minutes; and
iii. removing the separate amino acids from the top of the ultra filter; and
(e) analyzing the separate amino acids by ultra high performance liquid chromatography.

18. The method of claim 17, further comprising the addition of isopropanol to the ground food protein.

19. The method of claim 17, wherein the buffered protein source suspension has a pH of about 7.2.

20. The method of claim 19, wherein enzyme-containing solutions are added to the defatted protein source in a single step.
